(19) United States
(12) Patent Application Publication
(10) Pub. No.: US 2012/0126711 A1
(43) Pub. Date: May 24, 2012

(54) PLANAR LIGHT EMITTING DEVICE

(75) Inventors: Shinji Suminoe, Osaka-shi (JP); Mitsuru Hineno, Osaka-shi (JP); Masato Onoue, Osaka-shi (JP)

(73) Assignee: SHARP KABUSHIKI KAISHA, Osaka-shi, Osaka (JP)

(21) Appl. No.: 13/383,785

(22) PCT Filed: Nov. 24, 2010
(86) PCT No.: PCT/JP2010/070916

§ 371 Date: Jan. 12, 2012

(51) Int. Cl. H05B 37/02

(52) U.S. Cl. 315/185 R; 315/294

(57) ABSTRACT

A sensor circuit or a display apparatus from which a highly accurate sensor output can be obtained includes a photodiode, a capacitor that is connected to the photodiode via an accumulation node and accumulates charges according to an electric current in the photodiode; a sensor switching element transistor that causes the accumulation node and an output line to be conductive with respect to each other in response to a readout signal and outputs an output signal according to the potential of the accumulation node to the output line; a variable capacitor that is provided between the accumulation node and an input electrode, and whose capacitance varies when a pressure is applied by a touching operation; and a control switching element transistor to which a control signal for switching conduction and non-conduction between the variable capacitor and the accumulation node is input.

### REFERENCE TO RELATED APPLICATIONS

This application is the national stage under 35 USC 371 of International Application No. PCT/JP2010/070916, filed Nov. 24, 2010, which claims the priority of Japanese Patent Application No. 2009-290836, filed Dec. 22, 2009, the entire contents of which are incorporated herein by reference.

### FIELD OF THE INVENTION

The present invention relates to a planar light emitting device. More particularly, the present invention relates to a planar light emitting device in which a plurality of solid-state light emitting elements are used as a light source.

### BACKGROUND OF THE INVENTION

As planar light emitting devices related to the present invention, a device in which the distribution density of LEDs in a central part is increased to be higher than the distribution density in an outer part for increasing the luminance of the central part of the light-emitting surface and a device in which LEDs disposed in a central part are supplied with a larger current than LEDs disposed in an outer part are known (see Patent Document 1, for example).
Patent Document 1: Japanese Unexamined Patent Publication No. 2007-317423

### SUMMARY OF THE INVENTION

As a backlight of liquid crystal displays such as liquid crystal display televisions and liquid crystal display monitors, a planar light emitting device with the use of solid-state light emitting elements such as LEDs (Light Emitting Diodes) is used.

In terms of cost-reduction and power-saving, it is demanded that such a planar light emitting device should provide a desired luminance with as few solid-state light emitting elements as possible.

When solid-state light emitting elements are arranged within a surface at regular intervals, or they are arranged in a concentrated manner in a central part as in the case of the planar light emitting device disclosed in Patent Document 1, the central part, which has poor heat dissipation properties, will have significant temperature rise, because the solid-state light emitting elements generate heat upon light emission.

In particular, when surrounded with a cabinet and maintained upright to be used as a backlight unit of a liquid crystal display, the solid-state light emitting elements will be affected by convection of air warmed in the cabinet to cause significant temperature rise in the central and upper central parts.

Solid-state light emitting elements such as LEDs subjected to temperature rise result not only in reduced luminous efficiency and increased electric power consumption but also in reduced transmittance due to deteriorated sealing resin and shortened lifetime due to a rupture resulting from a creep phenomenon in a solder joint with a mounting substrate.

It is therefore difficult to ensure reliability merely by increasing the distribution density of the solid-state light emitting elements in the central part or increasing the electric power supply to the central part, because these techniques allow excessive temperature rise in the solid-state light emitting elements in the central part.

In view of the above-described circumstances, the present invention has been achieved to provide a highly-reliable planar light emitting device that can produce a desired luminance with a minimum number of solid-state light emitting elements while maintaining uniform temperature distribution.

The present invention provides a planar light emitting device, comprising: a planar base body; a plurality of solid-state light emitting elements distributed on the base body; and a control circuit for controlling the magnitude of the current to be supplied to the solid-state light emitting elements, wherein the base body has a plurality of areas having different distribution densities of the solid-state light emitting elements, and the control circuit controls the magnitude of the current so that the solid-state light emitting elements in an area having a lower distribution density are supplied with a larger current than the solid-state light emitting elements in an area having a higher distribution density.

According to the present invention, the solid-state light emitting elements in the area having a lower distribution density are supplied with a larger current than the solid-state light emitting elements in the area having a higher distribution density thereby to allow the solid-state light emitting elements in the area having a lower distribution density to emit light at a high luminance while preventing temperature rise in the solid-state light emitting elements in the area having a higher distribution density. It is therefore possible to attain a desired luminance with a minimum number of solid-state light emitting elements while maintaining uniform temperature distribution and provide a highly-reliable planar light emitting device by appropriately setting the distribution density of the solid-state light emitting elements and the magnitude of the current to be supplied.

### BRIEF DESCRIPTION OF THE DRAWINGS

FIG. 1 is a side view of a planar light emitting device according to an embodiment of the present invention.

FIG. 2 is an enlarged view of major portions of LED mounting areas of the planar light emitting device illustrated in FIG. 1 as viewed from above.

FIG. 3 is an explanatory diagram illustrating a schematic configuration of a liquid crystal display in which the planar light emitting device illustrated in FIG. 1 is used as a backlight.

### DETAILED DESCRIPTION OF THE INVENTION

The planar light emitting device according to the present invention comprises: a planar base body; a plurality of solid-state light emitting elements distributed on the base body; and a control circuit for controlling magnitude of a current to be supplied to the solid-state light emitting elements, and is characterized in that the base body has a plurality of areas having different distribution densities of the solid-state light emitting elements and the control circuit controls the magnitude of the current so that the solid-state light emitting elements in an area having a lower distribution density are supplied with a larger current than the solid-state light emitting elements in an area having a higher distribution density.

The base body in the planar light emitting device according to the present invention means a member for supporting the plurality of solid-state light emitting elements distributed thereon.

The base body is not particularly limited and examples thereof include a chassis constituting a skeleton of the planar light emitting device.

The solid-state light emitting elements mean light emitting elements such as light emitting diodes (LEDs) and laser diodes (LDs), and may be in the form of a chip or a package finished with sealing and terminal formation for mounting.

The configuration of the control circuit is not particularly limited as long as the circuit can control the magnitude of the current to be supplied to the solid-state light emitting elements according to the distribution density of the solid-state light emitting elements.

In the planar light emitting device according to the present invention, the plurality of solid-state light emitting elements may be arranged so as to form a plurality of element rows aligned in parallel in a first direction, and intervals among the element rows adjacent to one another in a second direction perpendicular to the first direction may be varied according to the distribution density of the solid-state light emitting elements.

According to this configuration, the distribution density of the solid-state light emitting elements can be varied by varying the intervals among the element rows adjacent to one another in the second direction to facilitate setting of the distribution density.

In the above-described configuration in which the plurality of element rows aligned in parallel are formed, the plurality of solid-state light emitting elements forming each element row may be arranged at regular intervals in the first direction.

According to this configuration, occurrence of uneven luminance as a whole is reduced because of the regular intervals among the solid-state light emitting elements in the first direction.

In the above-described configuration in which the plurality of element rows aligned in parallel are formed, the plurality of solid-state light emitting elements forming each element row may be connected in series.

According to this configuration, the magnitude of the current to be supplied can be varied every element row to facilitate control.

In the planar light emitting device according to the present invention, the base body may have a central area and two outer areas adjacent to the central area, and each of the outer areas may have a lower distribution density of the solid-state light emitting elements than the central area.

According to this configuration, the distribution density of the solid-state light emitting elements in each of the outer areas is set to be lower than that in the central area, whereas the current to be supplied to each of the outer areas is larger than that to be supplied to the central area. It is therefore possible to attain a desired luminance with fewer solid-state light emitting elements by supplying a larger current to each of the outer areas having enough heat dissipation properties while preventing temperature rise in the solid-state light emitting elements in the central area having poor heat dissipation properties. Thus, it is possible to attain a desired luminance with fewer solid-state light emitting elements while maintaining uniform temperature distribution.

In addition, the central area can have a higher luminance than each of the outer areas by appropriately setting the distribution density of the solid-state light emitting elements in each of the outer areas and the central area, and the magnitude of the current to be supplied to each of the areas.

In this case, it will be ergonomically recognized that the luminance of the entire light-emitting surface is improved, and uneven luminance will be less recognizable.

In the planar light emitting device according to the present invention, the base body may have a central area and two outer areas adjacent to the central area, and one of the outer areas and the central area may have lower distribution densities of the solid-state light emitting elements than the other of the outer areas.

According to this configuration, when the planar light emitting device is surrounded with a housing of a liquid crystal display device and maintained upright to be used as a backlight of the liquid crystal display device, the distribution density of the solid-state light emitting elements is set to be lower in an upper part of the planar light emitting device where the temperature easily rises due to convection of air warmed in the housing, that is, in one of the outer areas and the central area excluding the other of the outer areas, so that one of the outer areas and the central area are supplied with larger currents than the other of the outer areas.

Thus, it is possible to attain a desired luminance with fewer solid-state light emitting elements by supplying larger currents to one of the outer areas and the central area having enough heat dissipation properties while preventing temperature rise in the other of the outer areas where the heat dissipation properties will be deteriorated when the planar light emitting device is maintained upright for use. Thus, it is possible to attain a desired luminance with fewer solid-state light emitting elements while maintaining uniform temperature distribution.

In addition, the central area can have a higher luminance than each of the outer areas by appropriately setting the distribution density of the solid-state light emitting elements in each of the outer areas and the central area, and the magnitude of the current to be supplied to each of the areas.

In this case, it will be ergonomically recognized that the luminance of the entire light-emitting surface is improved, and uneven luminance will be less recognizable.

The planar light emitting device according to the present invention may further comprise a light diffusing member for covering the plurality of solid-state light emitting elements distributed on the base body.

According to this configuration, light emitted from the plurality of distributed solid-state light emitting elements can be diffused and radiated in various directions to effectively reduce occurrence of uneven luminance.

According to another aspect of the present invention, there is provided a liquid crystal display device in which the planar light emitting device according to the present invention is used as a backlight.

Examples of the liquid crystal display device include a liquid crystal display television and a liquid crystal display panel.

Hereinafter, a planar light emitting device according to an embodiment of the present invention will be described in detail based on the drawings.

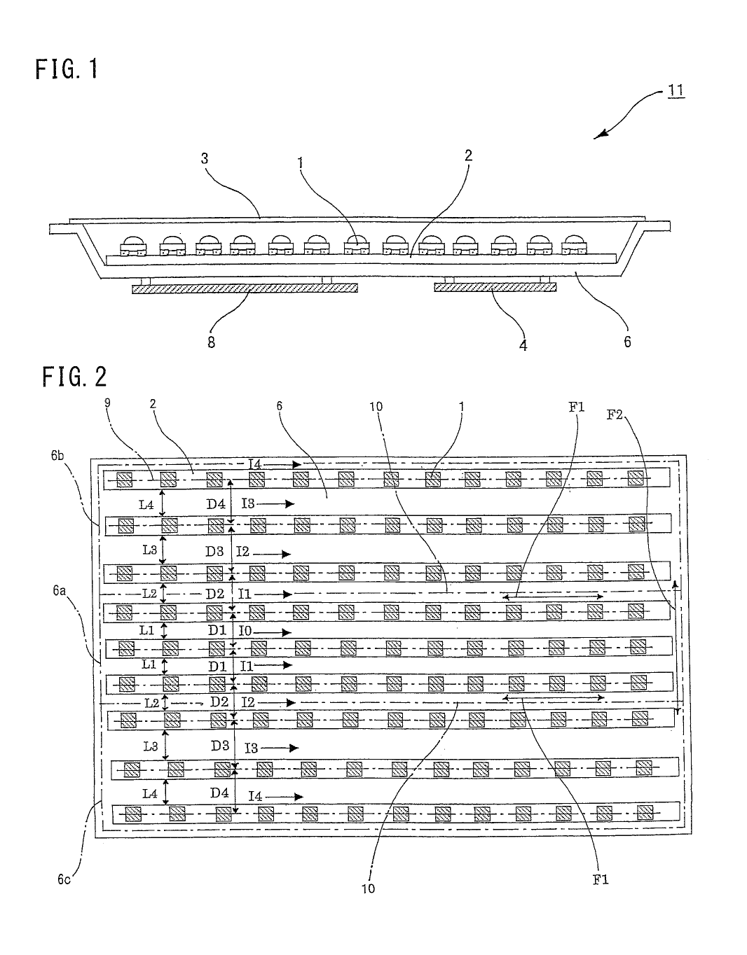

FIG. 1 is a side view of the planar light emitting device according to the embodiment of the present invention, and FIG. 2 is an enlarged view of major portions of LED mounting areas of the planar light emitting device illustrated in FIG. 1 as viewed from above.

As illustrated in FIGS. 1 and 2, a planar light emitting device 11 according to the embodiment of the present invention comprises: a planar chassis (base body) 6; a plurality of LEDs (solid-state light emitting elements) 1 distributed on the chassis 6; and a driving circuit board (control circuit) 4 for controlling magnitude of the current to be supplied to the LEDs 1, the chassis 6 has a central area 6a and outer areas 6b, 6c having a lower distribution density of the LEDs 1 than the central area 6a, and the driving circuit board 4 controls the magnitude of the current so that the LEDs 1 in the outer areas 6b, 6c having a lower distribution density are supplied with a larger current than the LEDs 1 in the central area 6a having a higher distribution density.

The planar light emitting device 11 comprises a light diffusing plate (light diffusing member) 3 disposed so as to cover the LEDs 1. The light diffusing plate 3 diffuses and radiates light incident from the LEDs 1 in various directions to reduce occurrence of uneven luminance.

The planar light emitting device 11 further comprises a plurality of long and narrow strip-shaped mounting substrates 2 for mounting the LEDs 1. Examples of the mounting substrates 2 usable here include an A1 substrate, a glass epoxy substrate and a paper phenol substrate, and a glass epoxy substrate, which is relatively inexpensive and highly reliable, is used in the present embodiment.

Desirably, the chassis 6 is made of a material having excellent heat conductance such as A1, but may be made of other materials such as steel plate, carbon and resins including ABS resin.

The mounting substrates 2 each have the LEDs 1 as solid-state light emitting elements mounted on one surface thereof by solder joint and are fixed to the chassis 6 with screws, rivets, double-stick tape, or the like. Each of the LEDs 1 is in the form called LED package obtained by mounting a single LED chip or a plurality of LED chips on a ceramic substrate and sealing the same with a resin.

In addition, the mounting substrates 2 adjacent to one another may be connected with a connector and may have a resistor, a coil, a temperature sensor, a luminance sensor, an LED driving element, or the like, not shown.

In the present embodiment, the LEDs 1 are mounted on each of the mounting substrates 2 at regular intervals in line in a longitudinal direction of the mounting substrates 2 to form element rows 9. The longitudinal direction of the mounting substrates 2 agrees with a direction F1 in which boundaries 10 between the central area 6a and each of the outer areas 6b, 6c extend (first direction or boundary direction). Besides, the mounting substrates 2 are disposed on the chassis 6 to be aligned in parallel at intervals in a direction F2 perpendicular to the direction F1 in which the boundaries 10 extend (second direction or direction perpendicular to the boundary direction). Thus, the element rows 9 extend in the direction F1 of the boundaries 10 and are aligned in parallel at intervals in the direction F2 perpendicular to the direction F1 of the boundaries 10. In the present embodiment, the mounting substrates 2 have a common constitution.

The intervals among the mounting substrates 2 adjacent to one another are varied to vary the intervals among the element rows 9 adjacent to one another thereby to vary the distribution density of the LEDs 1 within the surface so that the outer areas 6b, 6c have a lower distribution density of the LEDs 1 than the central area 6a.

Specifically, as illustrated in FIG. 2, the mounting substrates 2 adjacent to one another are arranged so that the intervals thereamong are increased gradually with distance from the central area 6a to each of the outer areas 6b, 6c in the direction F2 perpendicular to the direction F1 of the boundaries 10, that is, in order of L1, L2, L3 and L4. The intervals L1, L2, L3, L4 satisfy the following relationship: L4>L3>L2>L1.

Thereby, the intervals among the element rows 9 adjacent to one another in the direction F2 perpendicular to the direction F1 of the boundaries 10 are also increased gradually with distance from the central area 6a to each of the outer areas 6b, 6c in the direction F2, that is, in order of D1, D2, D3 and D4. The intervals D1, D2, D3, D4 satisfy the following relationship: D4>D3>D2>D1.

That is, in the present embodiment, the distribution density of the LEDs 1 can be adjusted by using the common mounting substrates 2 and adjusting the intervals among the mounting substrates 2 adjacent to one another to greatly facilitate the setting of the distribution density. In addition, since the common mounting substrates 2 are used, the planar light emitting device 11 is adaptable to a change of the specification of the device. Furthermore, since the LEDs 1 are mounted on each of the mounting substrates 2 at regular intervals in the longitudinal direction of the substrates, the intervals among the LEDs 1 in the direction F1 of the boundaries 10 are even over the whole area of the planar light emitting device 11 to reduce occurrence of uneven luminance.

Preferably, surfaces of the chassis 6 and the mounting substrates 2 excluding areas for mounting the LEDs 1 are covered with a reflective sheet, not shown, to enhance light use efficiency.

On the backside of the chassis 6, provided is the driving circuit board 4 having a control circuit for controlling the magnitude of the current to be supplied to the LEDs 1 according to the distribution density of the LEDs 1.

The plurality of LEDs 1 forming each of the element rows 9 are connected in series on the mounting substrates 2 so that the control circuit of the driving circuit board 4 can control the magnitude of the current to be supplied with respect to each element row 9.

In the present embodiment, the magnitude of the current is controlled so that a larger current is supplied to an area having a lower distribution density of the LEDs 1 in order to attain a desired luminance with fewer LEDs 1 while maintaining uniform temperature distribution of the LEDs 1 within the surface.

Specifically, as illustrated in FIG. 2, the current value to be supplied is increased gradually with distance from the central element rows 9 to the outer element rows 9 in order of I0, I1, I2, I3 and I4 so that the magnitude of the power to be supplied is increased gradually with distance from the central area 6a to each of the outer areas 6b, 6c having a lower distribution density of the LEDs 1. The current values I4, I3, I2, I1, I0 satisfy the following relationship: I4>I3>I2>I1>I0.

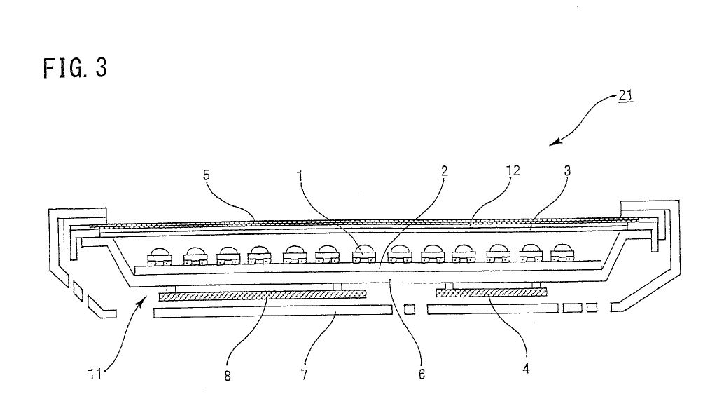

FIG. 3 illustrates a liquid crystal display 21 in which the planar light emitting device 11 according to the present embodiment is used as a backlight. FIG. 3 is an explanatory diagram illustrating a schematic configuration of the liquid crystal display 21 in which the planar light emitting device 11 according to the present embodiment is used as a backlight.

When the planar light emitting device 11 according to the present embodiment is used as a backlight of the liquid crystal display 21 as illustrated in FIG. 3, an optical sheet group 12 including a prism sheet, a lens sheet, and the like is disposed on the light diffusing plate 3, and a liquid crystal panel 5 is provided on the optical sheet group 12.

The optical sheet group 12 has various optical functions such as a function of concentrating brightness in the front direction and a function of transmitting only light in the direction of the polarizing axis of the liquid crystal to improve the transmittance in the liquid crystal.

On the backside of the chassis 6, provided is an image processing substrate 8 for converting image signals input from the outside into signals suitable for the liquid crystal and performing image processing.

On the outside of the substrate, a cabinet (housing) 7 is provided so as to cover the planar light emitting device 11 and the liquid crystal panel 5 for purposes of design, protection of the driving circuit board 4 and the image processing substrate 8, and ensuring of safety.

For the cabinet 7, resins such as ABS resins, polycarbonate resins, acrylic resins, carbon and composite materials thereof, A1, magnesium alloys, or metal plates may be used, and a polycarbonate, which is inexpensive and lightweight, is used in the present embodiment.

Surrounded with the liquid crystal panel 5 and the cabinet 7, the planar light emitting device 11 in the liquid crystal display 21 having such a configuration has poor heat dissipation properties and easily increases in temperature due to heat generated from the driving circuit board 4 and the image processing substrate 8.

Besides, the central area 6a of the planar light emitting device 11 easily keeps heat as being surrounded with the outer areas 6b, 6c and therefore having a long heat conduction path.

However, as described above, the planar light emitting device 11 according to the present embodiment can maintain uniform thermal distribution within the surface and attain a desired luminance with a minimum number of the LEDs 1, because the intervals among the mounting substrates 2 adjacent to one another are increased gradually with distance from the central area 6a to each of the outer areas 6b, 6c in order of L1, L2, L3 and L4, and the magnitude of the current to be supplied to the element rows 9 is increased gradually with distance from the central area 6a to each of the outer areas 6b, 6c in order of I0, I1, I2, I3 and I4. In addition, the intervals D1 D2, D3, D4 among the element rows 9 and the current values I0, I1, I2, I3, I4 are increased so that the luminance of the central area 6a is higher than the luminance of each of the outer areas 6b, 6c to produce an ergonomic visual effect as if the luminance of the entire light-emitting surface were increased and make uneven luminance less recognizable. Hereinafter, a specific example will be used to give a detailed description.

Since the description takes, as the specific example, a liquid crystal display in which a conventional planar light emitting device different from the planar light emitting device 11 according to the present embodiment is used as a backlight, the description will not be accompanied by the reference numerals.

For example, in the case of a 40-inch liquid crystal display, a central part and an outer part of the planar light emitting device can have a temperature difference of approximately 15° C.

When a power of approximately 200 W (LED-related electric power consumption: 160 W+electric power consumption by various substrates: 40 W) is supplied, the temperature of mounting substrates having LEDs in the central part, where the temperature reaches a peak, can be 30° C. to 35° C. higher than the temperature of an outer part, though it depends on the power to be supplied.

In addition, in the case of the use of LEDs with a ceramic package having relatively good heat characteristics of a thermal resistance of approximately 45° C./W on the condition that it is mounted on a substrate, the thermal resistance of a mounting substrate and the LED terminals is approximately 25° C./W, though the temperature of solder joints of the LEDs varies depending on the material of the mounting substrate and the package structure of the LEDs.

The thermal resistance is represented by the following formula (1):

ΔT=R×Q (1)

wherein, ΔT is a temperature difference (° C.) between objects giving and receiving heat, R is a thermal resistance (° C./W), and Q is a heat flow (W).

Considering long-term reliability, it is generally desirable to suppress temperature rise in the solder joints to a minimum. In particular, for liquid crystal displays, which is required to be secure for tens of thousands of hours and considered as a defective even if only one LED is damaged. Therefore, the temperature of the LED terminals needs to be suppressed to approximately 45° C. at maximum.

Accordingly, a part of the mounting substrates that will reach a maximum temperature of 35° C. when the LEDs are not driven will be allowed to rise in temperature only by 10° C. when the LEDs are driven.

Here, when this allowable temperature as the temperature difference ΔT between objects, and the above mentioned thermal resistance of 25° C./W of the wiring substrate and the LED terminals as the thermal resistance R are assigned to the formula (1) for calculation, then it is found that only 0.4 W can be supplied to the part concerned.

When the current values within the surface are set to be the same under this condition, the power to be supplied to the outer part must be saved due to the limitation of the power being supplied to the central part though more power could be supplied to the outer part, and the luminous flux emitted by the LEDs is therefore limited, too.

However, when the LEDs are distributed within the surface at regular intervals and when the temperature difference between the central part and the outer part is 15° C. and the temperature of the mounting substrates in the central part is 35° C., the temperature of the mounting substrates in the outer part is 20° C., allowing a temperature rise by 25° C., that is, up to 45° C., which is the upper limit of the temperature of the LED terminals in the outer part.

When this allowable temperature is assigned to the formula (I) for calculation as in the case of the earlier example, then it is found that a more power of 1.0 W can be supplied to the LEDs in the outer part, to put it simply.

Actually, even in view of temperature rise in the mounting substrates themselves to be caused by the increase of the power supplied to the LEDs, approximately 0.8 W can be supplied to obtain a nearly doubled luminous flux.

On the assumption that the luminous flux twice the luminous flux to be obtained under the conventional driving condition can be obtained from the LEDs in the outer part, a predetermined luminance can be obtained even if the number of LEDs to use is decreased to 1/√2, that is, to approximately 0.7 times, as long as the intervals among the LEDs in the lateral direction (direction of a boundary between the central area and the outer area) are kept the same and the intervals in the longitudinal direction (direction perpendicular to the direction of the boundary) are doubled while taking a measure by, for example, expanding the luminous flux from the LEDs with a diffusing lens in the outer part for preventing uneven luminance even when the intervals are increased.

Thus, even when the distribution density of the LEDs 1 is reduced in each of the outer areas 6b, 6c as in the case of the planar light emitting device 11 according to the present embodiment, it is possible to attain a desired luminance by supplying a current large enough to compensate the reduced distribution density of the LEDs 1 in the outer areas 6b, 6c.

Besides, it is possible to maintain uniform thermal distribution within the surface while attaining a desired luminance, when the intervals among the mounting substrates 2 adjacent to one another are increased gradually with distance from the central area 6a to each of the outer areas 6b, 6c in order of L1, L2, L3 and L4, and the current to be supplied to the element rows 9 is increased gradually with distance from the central area 6a to each of the outer areas 6b, 6c in order of I0, I1, I2, I3 and I4 as in the case of the planar light emitting device 11 according to the present embodiment.

Moreover, it is possible to create a condition where the luminance of the central area 6a is higher than the luminance of each of the outer areas 6b, 6c with a minimum number of the LEDs 1 and obtain an ergonomic visual effect of recognition as if the luminance of the entire light-emitting surface were increased by appropriately setting the intervals L1, L2, L3, L4 among the mounting substrates 2 adjacent to one another and the current values I0, I1, I2, I3, I4 to be supplied to each of the element rows 9.

In short, the current value, which has been determined uniformly based on the LEDs 1 disposed in the central area 6a having poor heat dissipation properties, is reconsidered to configure the outer areas 6b, 6c having enough heat dissipation properties to receive a larger current value and have a lower distribution density of the LEDs 1, and as a result, the planar light emitting device 11 according to the present embodiment can produce a desired luminance with a minimum number of the LEDs 1 while maintaining uniform temperature distribution within the surface.

In the present embodiment, as described above, the distribution density of the LEDs 1 within the surface is varied by arranging the LEDs 1 at regular intervals in the direction F1 in which the boundaries 10 between the central area 6a and each of the outer areas 6b, 6c extend and varying the intervals among the mounting substrates 2 adjacent to one another in the direction F2 perpendicular to the direction F1 in which the boundaries 10 extend.

However, the technique for varying the distribution density of the LEDs 1 is not limited to this, and the distribution density of the LEDs 1 within the surface may be varied by arranging the LEDs 1 at regular intervals in the direction F2 and varying the intervals among the LEDs 1 in the direction F1, for example.

In this case, the distribution density of the LEDs 1 within the surface may be varied by orienting the longitudinal direction of the mounting substrates 2 in the direction F2, arranging the mounting substrates 2 at intervals in parallel in the direction F1 and varying the intervals among the mounting substrates 2 adjacent to one another in the direction F1.

Alternatively, the LEDs 1 may be arranged so that the outer areas have a lower distribution density of the LEDs 1 than the central area by varying the intervals among the LEDs 1 both in the direction F1 and the direction F2.

In this case, the LEDs 1 may be mounted on the strip-shaped mounting substrates 2 at unequal intervals and the intervals among the mounting substrates 2 adjacent to one another may be varied, or the LEDs 1 may be mounted on a single large mounting substrate or a plurality of large mounting substrates at unequal intervals both in the directions F1 and F2.

Alternatively, a wire circuit may be formed on the chassis 6, and the LEDs 1 may be mounted directly on the chassis 6 at unequal intervals both in the directions F1 and F2 without using the mounting substrates 2 so that the outer areas have a lower distribution density of the LEDs 1 than the central area.

When the LEDs 1 are arranged at unequal intervals both in the directions F1 and F2 as described above, each of the LEDs 1 may be independently driven, and the driving circuit board (control circuit) 4 may control the current values so that a larger current is supplied to an area with distribution density of the LEDs 1 becomes lower.

In the present embodiment, in addition, the LEDs 1 are arranged in a lattice pattern where the adjacent LEDs form a line both in the directions F1 and F2, but the arrangement of the LEDs 1 is not necessarily limited to this and may be in a staggered pattern where the adjacent LEDs are in different lines, for example.

In the present embodiment, furthermore, the LEDs 1 are arranged so that the distribution density of the LEDs 1 is decreased with distance from the central area 6a to each of the outer areas 6b, 6c, but the LEDs 1 may be arranged so that the distribution density of the LEDs 1 is the highest in the outer area 6b and decreased gradually with distance from the outer area 6b to the outer area 6c via the central area 6a. In this case, the driving circuit board (control circuit) 4 controls the current values so that the current to be supplied to the LEDs 1 is increased gradually with distance from the outer area 6b to the outer area 6c via the central area 6a according to the distribution density of the LEDs 1.

According to this configuration, when the planar light emitting device having such a configuration is used as a backlight of a liquid crystal display and the liquid crystal display is maintained upright for use, it is possible to prevent temperature rise in an upper part of the backlight, i.e. in the outer area 6b where the temperature reaches a peak due to convection of air warmed in the cabinet while ensuring a predetermined luminance, and besides it is possible to maintain uniform temperature distribution within the surface while reducing the number of the LEDs 1 to be used in the planar light emitting device as a whole.

According to the present invention, as described above, the solid-state light emitting elements in an area having a lower distribution density are supplied with a larger current than the solid-state light emitting elements in an area having a higher distribution density thereby to allow the solid-state light emitting elements in the area having a lower distribution density to emit light at a high luminance while preventing temperature rise in the solid-state light emitting elements in the area having a higher distribution density. It is therefore possible to attain a desired luminance with a minimum number of solid-state light emitting elements while maintaining uniform temperature distribution and provide a highly-reliable planar light emitting device by appropriately setting the distribution density of the solid-state light emitting elements and the magnitude of the current to be supplied.

1. A planar light emitting device comprising:
a planar base body;
a plurality of solid-state light emitting elements distributed on the base body; and
a control circuit for controlling the magnitude of the current to be supplied to the solid-state light emitting elements;
wherein the base body has a plurality of areas having different distribution densities of the solid-state light emitting elements; and
the control circuit controls the magnitude of the current so that the solid-state light emitting elements in an area having a lower distribution density are supplied with a larger current than the solid-state light emitting elements in an area having a higher distribution density.

2. A planar light emitting device of claim 1, wherein the plurality of solid-state light emitting elements are arranged so as to form a plurality of element rows aligned in parallel in a first direction, and intervals among the element rows adjacent to one another in a second direction perpendicular to the first direction are varied according to the distribution density of the solid-state light emitting elements.

3. A planar light emitting device of claim 2, wherein the plurality of solid-state light emitting elements forming each element row are arranged at regular intervals in the first direction.

4. A planar light emitting device of claim 2, wherein the plurality of solid-state light emitting elements forming each element row are connected in series.

5. A planar light emitting device of claim 3, wherein the plurality of solid-state light emitting elements forming each element row are connected in series.

6. A planar light emitting device of claim 1, wherein the base body has a central area and two outer areas adjacent to the central area, and each of the outer areas has a lower distribution density of the solid-state light emitting elements than the central area.

7. A planar light emitting device of claim 1, wherein the base body has a central area and two outer areas adjacent to the central area, and one of the outer areas and the central area have lower distribution densities of the solid-state light emitting elements than the other of the outer areas.

8. A planar light emitting device of claim 1, further comprising a light diffusing member for covering the plurality of solid-state light emitting elements distributed on the base body.

9. A planar light emitting device of claim 6, further comprising a light diffusing member for covering the plurality of solid-state light emitting elements distributed on the base body.

10. A planar light emitting device of claim 7, further comprising a light diffusing member for covering the plurality of solid-state light emitting elements distributed on the base body.

11. A backlight for a liquid crystal display device comprising the planar light emitting device of claim 1.
